(19) United States
(12) Patent Application Publication
(10) Pub. No.: US 2012/0077592 A1
(43) Pub. Date: Mar. 29, 2012

(54) SOUND PROCESSING DEVICE, SOUND PROCESSING METHOD, INFORMATION STORAGE MEDIUM, AND PROGRAM

(76) Inventor: Yuichi Asami, Tokyo (JP)

(21) Appl. No.: 13/375,378

(22) PCT Filed: May 27, 2010
(86) PCT No.: PCT/JP2010/058999

§ 371 Date: Nov. 30, 2011

(30) Foreign Application Priority Data
Jun. 2, 2009 (JP) 2009-132875

(51) Int. Cl. G06F 17/00

(52) U.S. Cl. 463/35

(57) ABSTRACT

Sound output units (201A, 201B) output sounds, respectively. A detection unit (202) detects existence/absence of depression performed by a player on each of a plurality of operation targets to be operated. A sound volume changing unit (203) changes the volume ratio of a sound to be output from each of the sound output units (201A, 201B) based on an operation target whose depression has been detected among the plurality of operation targets. For example, the sound volume changing unit (203) relatively increases the volume of a sound to be output from a sound output unit among the sound output units (201A, 201B) which is far from the operation target whose depression has been detected.

### TECHNICAL FIELD

The present invention relates to a sound processing device, a sound processing method, an information storage medium and a program that can output sounds in a volume balance which makes it easier for players to hear the sounds.

### BACKGROUND ART

There is a game while a player plays while moving in real space. For example, with a game device disclosed in Patent Literature 1, a player moves while stepping on a panel according to music and timing directions for stepping operations. Accordingly, the player can enjoy dance feeling. This game device detects a stepping operation by the player on a step-on platform incorporating step sensors. Further, this game device provides evaluation results on the player's stepping operations.

Patent Literature 1: Japanese Patent No. 3003851

### SUMMARY OF INVENTION

### Technical Problem

By the way, speakers which output music or the like are often fixed in predetermined positions. As mentioned above, there is a game which a player plays while moving as done in Patent Literature 1. In such a game, it may be difficult to listen to music depending on the place of the player present. For example, there is a case where a plurality of speakers are arranged to output sounds in a plurality of channels such as stereo sounds. In such a case, when the player moves, the player may come far away from a specific speaker. This upsets the balance of sound levels. Therefore, the player may have difficulty in listening to sounds.

This invention solves such a problem, and it is an object of the invention to provide a sound processing device, a sound processing method, an information storage medium and a program that can output sounds in a volume balance which makes it easier for players to hear the sounds.

### Solution to Problem

To achieve the object, the following invention is disclosed according to the principle of the invention.

A sound processing device according to a first aspect of the invention includes a plurality of sound output units, a detection unit, and a sound volume changing unit.

The plurality of sound output units output sounds.

The detection unit detects existence/absence of depression performed by a player on each of a plurality of operation targets to be operated arranged in predetermined positions.

The sound volume changing unit changes a volume ratio of a sound to be output from each of the plurality of sound output units based on an operation target whose depression has been detected among the plurality of operation targets.

The sound processing device outputs sounds of a game, a movie, an advertisement, etc., for example. At least one speaker is associated with each sound output unit. The sound processing device can output multi-channel sounds using a plurality of speakers. The sound processing device is connected with a device which detects whether there is depression performed by a player (which is generally called controller). For example, the controller may have a mat-type form placed on a floor. A plurality of buttons which accepts depression performed by a player may be arranged on the surface of the controller. Each of the buttons is also called operation target.

The sound processing device changes the volume ratio of a sound output from each speaker according to which one of the plurality of buttons arranged on the controller was pressed by a player. In other words, the sound processing device changes the volume ratio of a sound output from each speaker according to the place of the player. For example, the sound processing device may make the volume of a speaker far from the pressed button relatively larger than the volumes of other speakers.

Generally, assuming that the volume is fixed, the farther away from a speaker, the smaller sounds heard. However, if the volume of a speaker is set relatively larger as the speaker is located farther from the button pressed by the player, sounds are output in a larger volume, so that even if the player moves away from the speaker, it becomes easy to catch a sound from the speaker. According to the invention, the volume balance changes according to a button pressed by the player. Therefore, sounds can be output with the volume balance which makes it easy for the player to hear the sounds.

The sound processing device may further include a storage unit that prestores task information which associates an operation target to be subjected to depression by the player among the plurality of operation targets with a timing at which the depression is to be performed.

The sound volume changing unit may change the volume ratio at the timing to be stored based on the operation target whose depression is to be performed while the depression is not detected by the detection unit.

The sound processing device according to the invention can play a game in virtual space, and can output the sounds of the game. Tasks of the game which a player should achieve (clear) are prepared for the game that is played with the sound processing device. A game task is information which associates a button which a player should press, with the timing (time in the game) at which the player should press. It is desirable for a player to press a button specified in a game task at the timing specified in the game task.

The player can press any one or more of a plurality of buttons at an arbitrary timing. That is, depending on how a player performs an operation (how to progress the game), the player may not press any button at all. According to the invention, therefore, when it comes to the timing at which a game task indicates while depression by the player is not detected, the volume balance changes according to the button which is indicated by the game task.

For example, although the player attempts to press a button as indicated by a game task, the player may make a false step. In such a case, it is presumed that there is a high possibility that the player is near the button which the player has attempted to press. When a button is not pressed, therefore, the sound processing device sets the sound volume in a volume balance which makes it easy for the player to hear sounds at a place where it is assumed that the player is very likely to be located. Alternatively, in such a case, the sound processing device may set the volume in a volume balance which makes it easy for the player to hear the sounds at a place where the player is desirably be present. According to the invention, even if depression is not detected, sounds can be output in a volume balance which is presumed to make it easy for the player to hear the sounds.

The sound processing device may further include a performance determining unit that determines a performance of the player about the task information based on existence/absence of depression detected by the detection unit, and the task information stored in the storage unit.

When the performance determining unit determines that the performance is excellent, the sound volume changing unit may change the volume ratio of a sound to be output from each of the plurality of sound output units based on an operation target among the plurality of operation targets which is stored in association with a timing later than a current time and closest to the current time, and otherwise, the sound volume changing unit may change the volume ratio of a sound to be output from each of the plurality of sound output units based on an operation target whose depression has been performed among the plurality of operation targets.

The sound processing device according to the invention determines the performance of a player based on a game task defined beforehand and depression performed by a player. For example, the sound processing device determines that the performance of the player is excellent when the timing at which the player has pressed the button indicated by a game task is closer to the timing indicated by the game task.

If the sound processing device determines that the performance of the player about a certain game task is excellent, the sound processing device changes the sound volume to a volume balance which makes it easy for the player to hear sounds at the place where a button indicated by a next game task (button to be pressed next by the player). The player can naturally hear sounds with a good volume balance when the performance of the game is excellent. According to the invention, sounds can be output with a volume balance which makes it easy for the player to hear the sounds. Further, to achieve a next game task, the player should move near a position where the volume balance is good.

The sound volume changing unit may relatively increase a volume of a sound to be output by a sound output unit among the plurality of sound output units which is far from an operation target whose depression has been detected.

That is, the volume of sounds output is made larger as a speaker is located farther from the button pressed by the player. As a result, sounds will be output with a larger volume from the speaker far from the player. Even when the player is located far from the speaker, therefore, the player easily hears the sounds. According to the invention, the sound processing device can output sounds with a volume balance which makes it easy for the player to hear the sounds.

The sound volume changing unit may relatively increase a volume of a sound to be output by a sound output unit among the plurality of sound output units which is near an operation target whose depression has been detected.

That is, the volume of sounds output is made larger as a speaker is located closer to the button pressed by the player. According to the invention, it is possible to output sounds with a volume balance which makes it easy for the player to hear the sounds.

A sound processing device according to another aspect of the invention includes a storage unit, a plurality of sound output units, and a sound volume changing unit.

The storage unit prestores task information which associates an operation target to be subjected to depression by a player among a plurality of operation targets to be operated arranged in predetermined positions with a timing at which the depression is to be performed.

The plurality of sound output units output sounds.

The sound volume changing unit changes a volume ratio of a sound to be output from each of the plurality of sound output units based on an operation target among the plurality of operation targets which is associated with a timing which is determined by using the timing to be stored and a current time.

Like the above-describe sound processing device, the sound processing device according to the invention can play a game in virtual space, and can output the sounds of the game. Tasks of the game which a player should achieve are prepared for the game that is played with the sound processing device.

The sound processing device changes the volume ratio of a sound output from each speaker according to a button indicated by a next game task. A plurality of buttons are arranged on the controller. In other words, the sound processing device changes the volume ratio of a sound output from each speaker according to the position in which the player should be present next. The volume ratio can be set arbitrarily.

The sound processing device changes the volume balance according to a button indicated by a next game task which the player challenges. The sound processing device sets the volume balance which makes it easy for the player to hear sounds at a place where it is assumed that the player is very likely to be located or a place where the player is desirably be present. According to the invention, sounds can be output in a volume balance which is presumed to make it easy for the player who is challenging a game task to hear the sounds.

The sound volume changing unit may change the volume ratio of a sound to be output from each of the plurality of sound output units based on an operation target among the plurality of operation targets which is stored in the storage unit in association with a timing later than the current time and closest to the current time.

Here, an operation target which is stored in association with a timing later than the current time and closest to the current time is a button which is indicated by a game task which the player challenges next. That is, in the invention, the volume ratio of sounds output from each speaker changes according to the button indicated by the next game task. The player can naturally hear sounds with a good volume balance to clear a game task. According to the invention, sounds can be output in the volume balance which makes it easy for the player to hear the sounds.

The sound volume changing unit may relatively increase a volume of a sound to be output by a sound output unit among the plurality of sound output units which is far from an operation target which is stored in the storage unit in association with a timing later than the current time and closest to the current time.

That is, the volume of sounds to be output is set larger when a speaker is located farther from the button which is indicated by a next game task. Sounds are output in a large volume from a speaker which is located far from the position that the player is predicted to move next. Therefore, the player is easier to hear sounds at the time of challenging a next game task. According to the invention, the sound processing device can output sounds in the volume balance which makes it easy for the player to hear the sounds.

The sound volume changing unit may relatively increase a volume of a sound to be output by a sound output unit among the plurality of sound output units which is near an operation target which is stored in the storage unit in association with a timing later than the current time and closest to the current time.

That is, the volume of sounds to be output is set larger when the speaker is located closer to the button which is indicated by a next game task. To achieve the next game task, the player should move near a position where the volume is large. According to the invention, the player can obtain a hint in voice for capturing the game.

A sound processing method according to a further aspect of the invention is a sound processing method which is executed by a sound processing device having a plurality of sound output units, a detection unit, and a sound volume changing unit, and includes a sound outputting step, a detection step and a sound volume changing step.

In the sound outputting step, each of the plurality of sound output units outputs a sound.

In the detection step, it is detected whether there is depression performed by a player on each of a plurality of operation targets to be operated arranged in predetermined positions.

In the sound volume changing step, a volume ratio of a sound to be output from each of the plurality of sound output units is changed based on an operation target whose depression has been detected among the plurality of operation targets.

According to the invention, sounds can be output in the volume balance which makes it easy for the player to hear the sounds.

A sound processing method according to a further aspect of the invention is a sound processing method which is executed by a sound processing device having a storage unit, a plurality of sound output units, and a sound volume changing unit, and includes a sound outputting step and a sound volume changing step.

Task information which associates an operation target to be subjected to depression by a player among a plurality of operation targets to be operated arranged in predetermined positions with a timing at which the depression is to be performed is prestored in the storage unit.

In the sound outputting step, each of a plurality of sound output units outputs a sound.

In the sound volume changing step, a volume ratio of a sound to be output from each of the plurality of sound output units is changed based on an operation target among the plurality of operation targets which is associated with a timing which is determined by using the timing to be stored and a current time.

According to the invention, sounds can be output in the volume balance which makes it easy for the player to hear the sounds.

An information storage medium according to a further aspect of the invention stores a program allowing a computer to function as a plurality of sound output units, a detection unit and a sound volume changing unit.

The plurality of sound output units output sounds.

The detection unit detects existence/absence of depression performed by a player on each of a plurality of operation targets to be operated arranged in predetermined positions.

The sound volume changing unit changes a volume ratio of a sound to be output from each of the plurality of sound output units based on an operation target whose depression has been detected among the plurality of operation targets.

According to the invention, a computer can be functioned as a sound processing device which operates as mentioned above.

An information storage medium according to a further aspect of the invention stores a program allowing a computer to function as a storage unit, a plurality of sound output units, and a sound volume changing unit.

The storage unit prestores task information which associates an operation target to be subjected to depression by a player among a plurality of operation targets to be operated arranged in predetermined positions with a timing at which the depression is to be performed.

The plurality of sound output units output sounds.

The sound volume changing unit changes a volume ratio of a sound to be output from each of the plurality of sound output units based on an operation target among the plurality of operation targets which is associated with a timing which is determined by using the timing to be stored and a current time.

According to the invention, a computer can be functioned as a sound processing device which operates as mentioned above.

A program according to a further aspect of the invention allows a computer to function as a plurality of sound output units, a detection unit and a sound volume changing unit.

The plurality of sound output units output sounds.

The detection unit detects existence/absence of depression performed by a player on each of a plurality of operation targets to be operated arranged in predetermined positions.

The sound volume changing unit changes a volume ratio of a sound to be output from each of the plurality of sound output units based on an operation target whose depression has been detected among the plurality of operation targets.

According to the invention, a computer can be functioned as a sound processing device which operates as mentioned above.

A program according to a further aspect of the invention allows a computer to function as a storage unit, a plurality of sound output units and a sound volume changing unit.

The storage unit prestores task information which associates an operation target to be subjected to depression by a player among a plurality of operation targets to be operated arranged in predetermined positions with a timing at which the depression is to be performed.

The plurality of sound output units output sounds.

The sound volume changing unit changes a volume ratio of a sound to be output from each of the plurality of sound output units based on an operation target among the plurality of operation targets which is associated with a timing which is determined by using the timing to be stored and a current time.

According to the invention, a computer can be functioned as a sound processing device which operates as mentioned above.

The program according to the invention is recordable on a computer-readable information storage medium such as a compact disc, a flexible disk, a hard disk, a magneto-optical disc, a digital video disc, a magnetic tape or a semiconductor memory.

The program can be distributed and sold, independently of a computer which executes the program, over a computer communication network. The information storage medium can be distributed and sold independently of a computer.

### Advantageous Effects of Invention

The invention can provide a sound processing device, a sound processing method, an information storage medium and a program that can output sounds in a volume balance which makes it easier for players to hear the sounds.

### BRIEF DESCRIPTION OF DRAWINGS

FIG. 1 is a diagram showing the schematic configuration of a typical information processing apparatus which achieves a sound processing device according to the invention.

FIG. 2 is a diagram for explaining the functional configuration of the sound processing device.

FIG. 3 is a diagram showing an example of the arrangement of a controller, a monitor, and speakers.

FIG. 4 is a diagram showing an example of the arrangement of the controller, the monitor, and the speakers.

FIG. 5 is a diagram showing an example of the arrangement of the controller, the monitor, and the speakers.

FIG. 6 is a diagram showing an example of the structure of information which defines a volume ratio.

FIG. 7 is a flowchart for explaining sound processing.

FIG. 8 is a diagram for explaining the functional configuration of a sound processing device according to a second embodiment.

FIG. 9 is a diagram showing an example of the structure of the screen of a game which is played with the sound processing device.

FIG. 10 is a flowchart for explaining sound processing.

FIG. 11 is a diagram for explaining the functional configuration of a sound processing device according to a third embodiment.

FIG. 12 is a flowchart for explaining sound processing.

FIG. 13 is a diagram for explaining the functional configuration of a sound processing device according to a fourth embodiment.

FIG. 14 is a flowchart for explaining sound processing.

FIG. 15A is a diagram showing the relation between an elapsed time and a change in volume.

FIG. 15B is a diagram showing the relation between an elapsed time and a change in volume.

FIG. 15C is a diagram showing the relation between an elapsed time and a change in volume.

FIG. 16 is a diagram showing an example of the arrangement of a controller, a monitor, and speakers.

### BEST MODE FOR CARRYING OUT THE INVENTION

### First Embodiment

An embodiment of the invention will be described below. For easier understanding, an embodiment by which the invention is realized using an information processing apparatus for games is described, but following embodiment is just illustrative and does not limit the scope of the invention. Therefore, a person skilled in the art can adopt embodiments in which each of these components or all the components are replaced with an equivalent or equivalents, and those embodiments are also included in the scope of the invention.

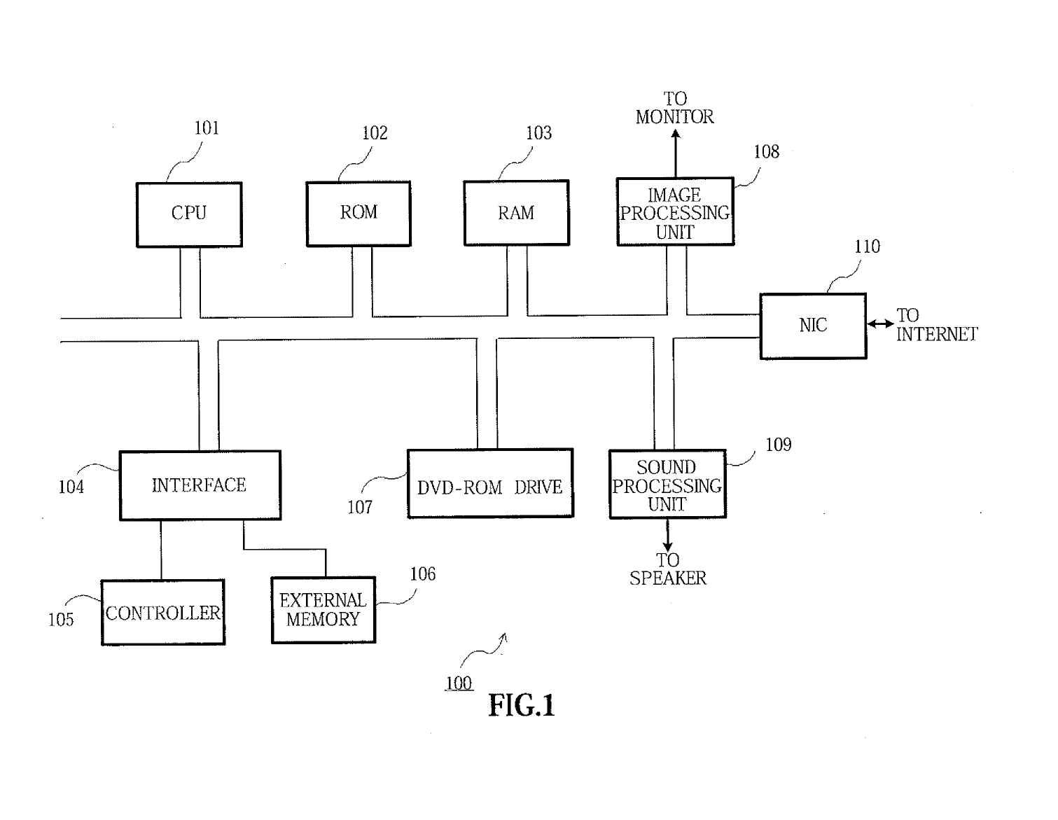

FIG. 1 is an exemplary diagram showing the schematic configuration of a typical information processing apparatus 100 which executes a program achieve the functions of the sound processing device according to the invention. The following description will be given with reference to this diagram.

The information processing apparatus 100 includes a CPU (Central Processing Unit) 101, a ROM (Read Only Memory) 102 and a RAM (Random Access Memory) 103, an interface 104, a controller 105, and an external memory 106, a DVD-ROM (Digital Versatile Disk-Read Only Memory) drive 107, an image processing unit 108, a sound processing unit 109, and an NIC (Network Interface Card) 110.

First, a player loads a DVD-ROM storing programs and data for a game into the DVD-ROM drive 107. When the player powers on the information processing apparatus 100, the program is executed to achieve the sound processing device of this embodiment.

The CPU 101 controls the general operation of the information processing apparatus 100. The CPU 101 is connected with the individual components. The CPU 101 exchanges control signals and data with the connected components. The CPU 101 can execute various operations on a register (not shown) using an ALU (Arithmetic Logic Unit) (not shown). The operations may be calculations such as addition, subtraction, multiplication and division, logical operations such as a logical sum, a logical product, and a logical NOT, or bit operations such as a bit sum, a bit product, bit flipping, bit shifting, and bit rotation. The register is a fast-accessible memory region. The CPU 101 itself may be configured to perform operations for multi-media processing at high speed. The CPU 101 may include a co-processor to perform operations for multi-media processing at high speed. The operations for multimedia processing include saturate calculations, such as addition, subtraction, multiplication and division, trigonometric functions, and vector operations.

An IPL (Initial Program Loader) which is executed immediately after powering on is recorded on the ROM 102. As the IPL is executed, a program recorded on the DVD-ROM is read into the RAM 103. Then, execution of the program by the CPU 101 is started. Programs and various kinds of data of an operating system which are needed for the general control of the information processing apparatus 100 are recorded on the ROM 102.

The RAM 103 stores data and a program temporarily. The RAM 103 holds a program and data read from the DVD-ROM in addition to data needed to progress a game and data for chat communications. The CPU 101 may provide a variable area in the RAM 103, and may perform operations by directly using the ALU to work on values stored in the variable. The CPU 101 may temporarily store values stored in the RAM 103 into the register. Further, the CPU 101 may perform operations on the register to carry out a process, such as writing the operation result back to the memory.

The controller 105 is connected via the interface 104 in a manipulatable manner. The controller 105 receives an operational input performed by a player at the time of playing a game, such as a dance game or a soccer game. A plurality of controllers 105 may be connected to the interface 104.

The external memory 106 is detachably connected via the interface 104. Data which indicates the play situations (past results or the like) of a game, data which indicates the progress of a game, data of a log (record) of chat communication of a game using a network, etc. are stored in the external memory 106. Data save in the external memory 106 is rewritable. These data may be recorded in the external memory 106 as needed when the player makes an operational input via the controller 105.

A DVD-ROM is loaded into the DVD-ROM drive 107. Programs which achieve a game and image data and sound data which accompany the game are recorded on the DVD-ROM. Under control of the CPU 101, the DVD-ROM drive 107 performs a reading process on the DVD-ROM loaded therein. Then, the DVD-ROM drive 107 reads a necessary program and necessary data. The read program and necessary data are temporarily stored in the RAM 103 or so.

The image processing unit 108 processes the data read from the DVD-ROM using an image processor (not shown) which is included in the CPU 101 or the image processing unit 108. Next, the image processing unit 108 records the processed data in a frame memory (not shown) which is included in the image processing unit 108. The image information recorded in the frame memory is converted into a video signal at a predetermined synchronous timing. Then, the video signal is output to a monitor (not shown) which is connected to the image processing unit 108. Accordingly, various kinds of image display are possible.

The image processor can execute, transparency operations such as an operation of overlaying two-dimensional images and alpha blending, and various kinds of saturate calculations at high speed.

The image processor can also perform an operation of acquiring a rendering image at high speed. A rendering image is an image of a polygon placed in virtual three-dimensional space and looked down in a predetermined direction of sight from a predetermined view position. The rendering image may be generated by placing a polygon in virtual three-dimensional space and rendering polygon information added with various kinds of texture information using a Z buffer scheme.

Further, the CPU 101 can collaborate with the image processor to draw a string of characters as a two-dimensional image. The CPU 101 and the image processor draw an image representing a character string according to font information which defines the fonts of characters. The character string may be drawn into a frame memory or onto each polygon surface.

Information such as images of a game may be prepared in the DVD-ROM. The situations or the like of the game can be displayed now on the screen by mapping the information onto the frame memory.

The sound processing unit 109 converts sound data read from the DVD-ROM into an analog sound signal. Then, the sound processing unit 109 outputs sounds from speakers (not shown) connected thereto. The sound processing unit 109 generates sound effects and music data to be generated during the progress of the game under control of the CPU 101. Further, the sound processing unit 109 outputs sounds corresponding to the generated sound effects and music data from the speakers.

When sound data recorded on the DVD-ROM is MIDI data, the sound processing unit 109 converts the MIDI data into PCM data by referring to sound source data the sound processing unit 109 has. When sound data recorded on the DVD-ROM is compressed sound data of an ADPCM (Adaptive Differential Pulse Code Modulation) form, an Ogg Vorbis form or the like, the sound processing unit 109 develops and converts the data into PCM data. When the sound processing unit 109 performs D/A (Digital/Analog) conversion of the PCM data at a timing according to the sampling frequency, and outputs the data to the speakers, sounds can be output.

The NIC 110 serves to connect the information processing apparatus 100 to a computer communication network (not shown), such as the Internet. The NIC 110 includes an Internet connecting device and an interface (not shown) which allows the CPU 101 to interface with the Internet connecting device. The Internet connecting device may be a device which conforms to 10BASE-T/100BASE-T standards and is used when constructing a LAN (Local Area Network), an analog modem for connecting to the Internet using a telephone line, an ISDN (Integrated Services Digital Network) modem, an ADSL (Asymmetric Digital Subscriber Line) modem, a cable modem for connecting to the Internet using a cable television circuit, or the like.

In addition, the information processing apparatus 100 may be constituted so as to achieve the same functions as the ROM 102, the RAM 103, the external memory 106, the DVD-ROM to be loaded into the DVD-ROM drive 107, etc. using a large-capacity external storage, such as a hard disk.

Next, the functional configuration of a sound processing device 200 according to this embodiment which is achieved by the information processing apparatus 100 having the foregoing configuration will be described.

The sound processing device 200 according to the embodiment outputs sounds of s music game which the sound processing device 200 executes. However, the sound processing device 200 may output sounds of another arbitrary game. The sound processing device 200 may output sounds of various contents, such as a movie and an advertisement.

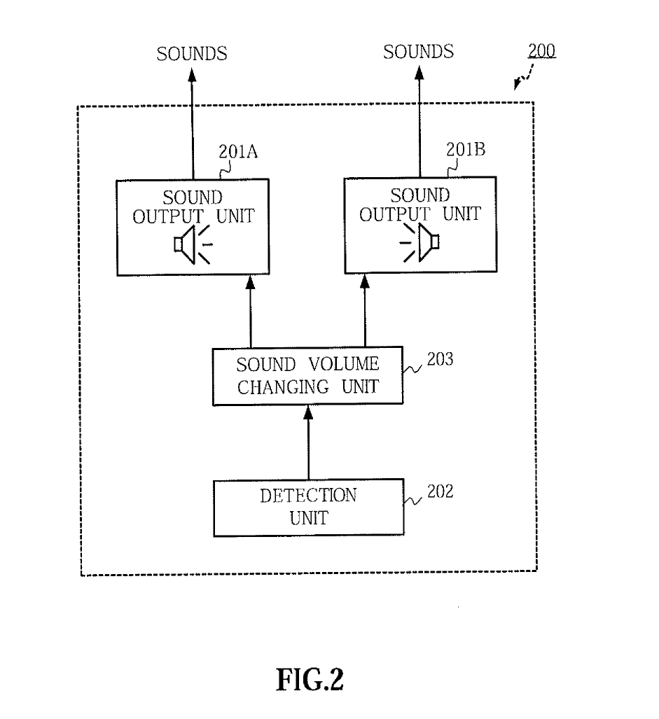

FIG. 2 is a diagram for explaining the functional configuration of the sound processing device 200. The sound processing device 200 is provided with a plurality of sound output units 201 (two units 201A and 201B in FIG. 2), a detection unit 202, and a sound volume changing unit 203.

Speakers are associated with the sound output units 201A and 201B, respectively. The sound output units 201A and 201B output reproduced sounds of converted PCM data or the like from the speakers.

Specifically, the CPU 101 reads music data from the DVD-ROM loaded into the DVD-ROM drive 107. Next, the CPU 101 causes the sound processing unit 109 to decode the music data according to a predetermined algorithm. Then, the CPU 101 reproduces sound data, and causes sounds to be output from the speakers. The CPU 101 can change the volume ratio of sounds output from each speaker as will be described later. The CPU 101 changes the volume ratio according to the position where it is presumed that the player is present or the progress of the game. The CPU 101 and the sound processing unit 109 collaborate to function as the sound output units 201A, 201B.

Each speaker is fixed to the position in real space. For example, the speaker of the sound output unit 201A is arranged on the left-hand side to the monitor connected to the sound processing device 200 as seen from the player. The speaker of the sound output unit 201A outputs left sounds (L sounds) which are desirable to be heard from the left-hand side to the player. The speaker of the sound output unit 201B is arranged on the right-hand side to the monitor connected to the sound processing device 200 as seen from the player. The speaker of the sound output unit 201B outputs right sounds (R sounds) which are desirable to be heard from the right-hand side to the player.

The sound processing device 200 may be provided with three or more sound output units 201. For example, the sound processing device 200 may be provided with six sound output units 201 to achieve a so-called 5.1 channel surround sound system. At least one speaker should be associated with each sound output unit 201.

The following will describe the embodiment where the sound processing device 200 includes two sound output units 201A and 201B.

The detection unit 202 detects whether the player has pressed the controller 105. The CPU 101 and the controller 105 collaborate to function as the detection unit 202.

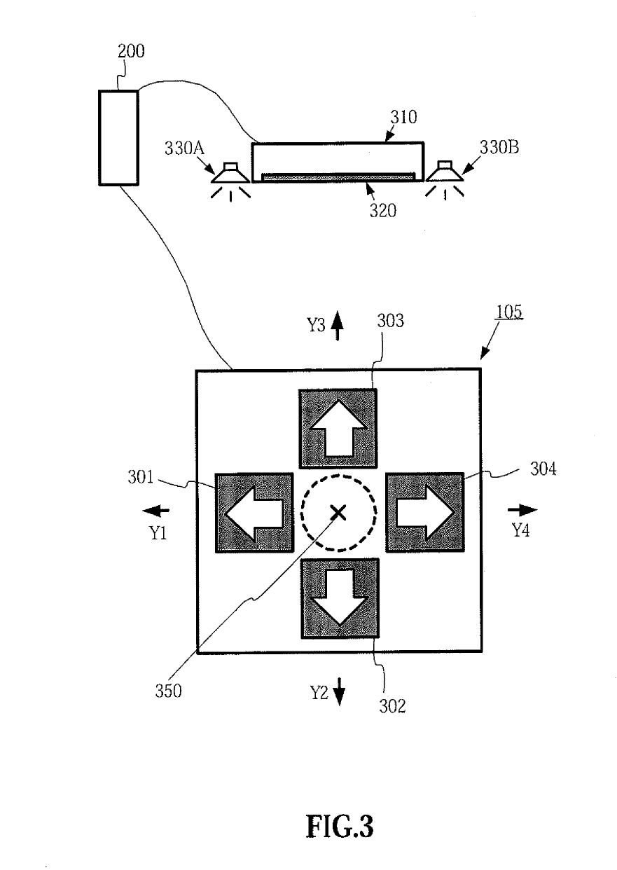

FIG. 3 is a diagram showing the arrangement when the controller 105 placed on the floor is seen from directly above. The controller 105 according to this embodiment is a mat-type controller to be placed on a floor. Buttons 301 to 304 are disposed in predetermined positions of the controller 105. The button 301 receives an input specifying “left” from the player. The button 302 receives an input specifying “down” from the player. The button 303 receives an input specifying “up” from the player. The button 304 receives an input specifying “right” from the player. The player can press the buttons 301 to 304 at an arbitrary timing.

The state where at least one button of the buttons 301 to 304 are pressed by the player is called “pressed state” herein. The state where the buttons 301 to 304 are not pressed is called “non-pressed state.” The CPU 101 detects whether each of the buttons 301 to 304 is in a pressed state or a non-pressed state.

The monitor 310 is arranged in the direction of an arrow Y3 of the controller 105 shown in FIG. 3. The screen of the game which is executed by the sound processing device 200 is displayed on the monitor 310. Fundamentally, the player stands facing the direction (Y3 direction) where the display surface 320 of the monitor 310 is present, and plays the game. The direction of an arrow Y1 is the left-hand side of the player. The direction of an arrow Y2 is the rear side of the player. The direction of an arrow Y4 is the right-hand side of the player. However, the direction of the player may change each time depending on how the player presses or the posture of the player.

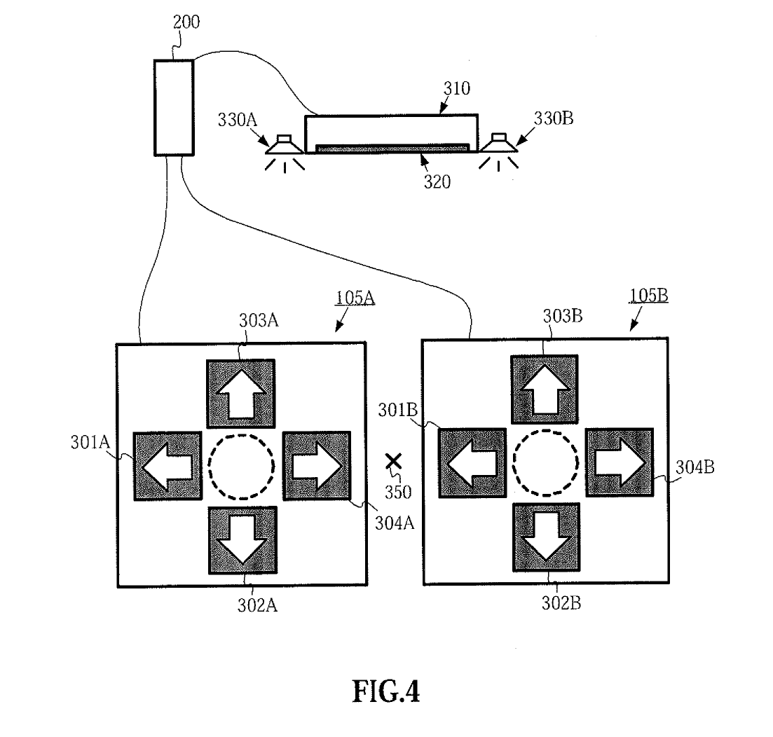

It is possible to connect two or more controllers 105 to the sound processing device 200. FIG. 4 is an outline view when two controllers 105A and 105B are connected to the sound processing device 200. Suppose that, for example, two players play the same game together. In this case, the first player operates the controller 105A, and the second player operates the controller 105B. Alternatively, one player may play the game using both controllers 105A and 105B.

Each of the buttons 301 to 304, buttons 301A to 304A, and buttons 301B to 304B is also called “operation target.” For example, an operation target may be provided with a sensor of a contact type. The state where the player is in contact with an operation target is the pressed state (ON). The state where the player is not in contact with an operation target is the non-pressed state (OFF).

The CPU 101 detects whether each of the operation targets (buttons 301 to 304, buttons 301A to 304A, buttons 301B to 304B) is in the pressed state or in the non-pressed state. Then, the CPU 101 stores a detection result in a predetermined region in the RAM 103. The CPU 101 detects whether each operation target is in the pressed state or in the non-pressed state at a regular time interval. Typically, the time interval may be the interval of timings of vertical synchronization interruption (VSYNC) or the like.

The sound volume changing unit 203 changes the volume ratio of sounds to be output from each of the sound output units 201A, 201B. The sound volume changing unit 203 changes the volume ratio based on the operation target whose depression has been detected among a plurality of operation targets.

The CPU 101 and the sound processing unit 109 collaborate to function as the sound volume changing unit 203.

The CPU 101 sets the volume of sounds to be output by a sound output unit which is located far from the operation target whose depression has been detected relatively larger. That is, the CPU 101 sets the volume of sounds to be output by that of the sound output units 201A, 201B which is located far from the operation target in the pressed state relatively larger than the volume of sounds to be output by other sound output unit.

Suppose that, for example, one controller 105 is connected to the sound processing device 200, only the button 301 is in the pressed state and the other buttons 302 to 304 are in the non-pressed state as shown in FIG. 3. In this case, the CPU 101 increases the volume of sounds to be output by the speaker 330B in the two speakers 330A, 330B which is far from the button 301 in the pressed state. The CPU 101 may not need to change the volume of sounds to be output from the other speaker 330A. The CPU 101 may lower the volume of sounds to be output from the other speaker 330A.

When only the button 301 is in the pressed state, it is presumed that the player is stepping on the button 301 on one foot (or on both feet), and the body position is moving in the Y1 direction. At this time, the distance between the position of the head of the player and the position of the speaker 330B is longer than the distance between the position of the head of the player and the position of the speaker 330A. If the volume is not changed, therefore, it is presumed that the player who operates the controller 105 hear sounds from the speaker 330B lower than sounds from the speaker 330A.

Generally, the creator of a game often create sound data on the assumption that a player is near the center of the controller 105. That is, a game creator assumes that the player is in a reference position 350 at an equal distance from both speakers 330A and 330B. Then, the game creator creates sound data in consideration of the balance of right and left volumes, a stereo effect, etc. Therefore, when the player moves from the reference position 350, the loudness of sounds heard from the two speakers 330A and 330B varies. Therefore, the player may have difficulty in hearing sounds, or may hear only L sounds or R sounds. Accordingly, the CPU 101 performs control such that the volume balance is maintained and sounds which are easier for the player to hear are output by setting the volume of sounds to be output from the speaker which is presumed to be far from the player relatively louder than the volume of sounds to be output from the other speaker.

Suppose that, for example, two controllers 105A and 105B are connected to the sound processing device 200, only the button 304B is in the pressed state and the other buttons 301A to 304A, 301B to 303B are in the non-pressed state as shown in FIG. 4. In this case, the CPU 101 increases the volume of sounds to be output by the speaker 330A in the two speakers 330A, 330B which is far from the button 304B in the pressed state. The CPU 101 may not change the volume of sounds to be output from the other speaker 330B. The CPU 101 may lower the volume of sounds to be output from the other speaker 330B.

When only the button 304B is in the pressed state, it is presumed that the player is standing close to the right-hand side facing the display surface 320 of the monitor 310. The distance between the position of the head of the player and the position of the speaker 330A is longer than the distance between the position of the head of the player and the position of the speaker 330B. That is, it is presumed that the speaker 330A is far from the player. Therefore, it is presumed that the player who operates the controller 105 is harder to hear sounds heard from the speaker 330A than sounds heard from the speaker 330B. Accordingly, the CPU 101 sets the volume of sounds to be output by the speaker 330A relatively larger than the volume of sounds to be output by the other speaker 330B. That is, the CPU 101 performs control such that the volume balance is maintained and sounds which are easier for the player to hear are output.

The CPU 101 may set the volume of sounds to be output by the sound output unit which is near an operation target in the pressed state relatively large. That is, the CPU 101 may set the volume of sounds to be output by the sound output unit whose depression has been detected relatively larger than the volume of sounds to be output by the other sound output unit. Suppose that, for example, only the button 301 is in the pressed state and the other buttons 302 to 304 are in the non-pressed state in FIG. 3. In this state, the CPU 101 may increase the volume of sounds to be output by the speaker 330A in the two speakers 330A and 330B which is near the button 301 in the pressed state. The CPU 101 may not change the volume of sounds to be output from the other speaker 330B. In addition, the CPU 101 may lower the volume of sounds to be output from the other speaker 330B.

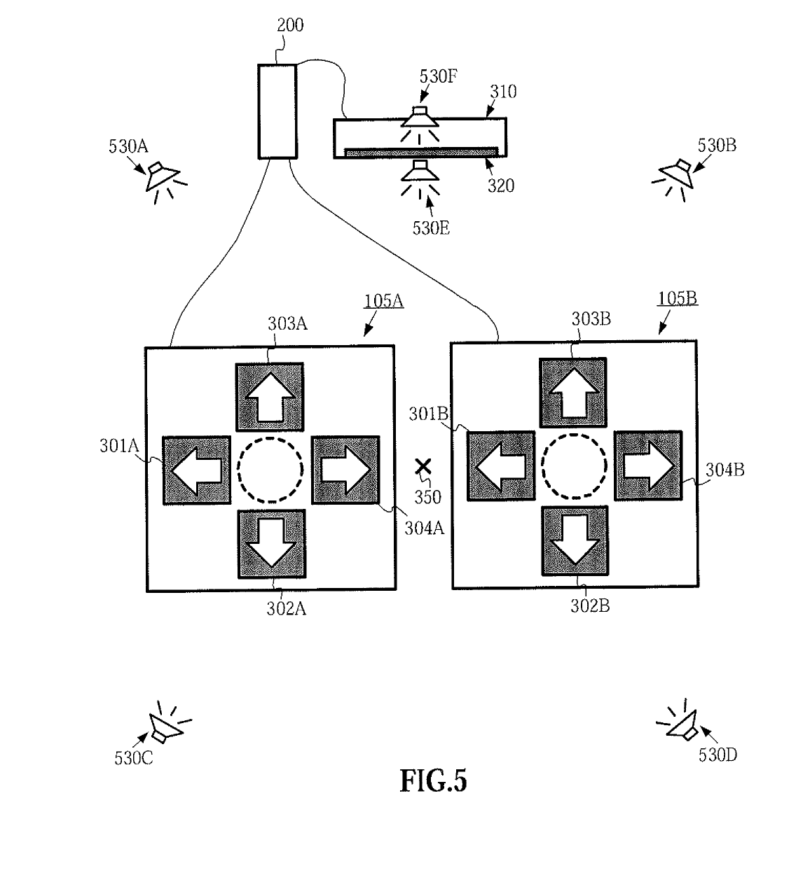

The number of speakers is not limited to two. For example, FIG. 5 is a diagram showing the embodiment where the two controllers 105A and 105B are connected to the sound processing device 200, and a multi-channel surround sound is adopted. In FIG. 5, a so-called 5.1 channel surround sound system is adopted. The sound output unit 201 is associated with the speakers as follows.

(1) First sound output unit: speaker 530A arranged in the left front.

(2) Second sound output unit: speaker 530B arranged in the right front.

(3) Third sound output unit: speaker 530C arranged in the left back.

(4) Fourth sound output unit: speaker 530D arranged in the right back.

(5) Fifth sound output unit: speaker 530E arranged in the center front (the front).

(6) Sixth sound output unit: speaker 530F for bass-generating subwoofer.

The CPU 101 detects whether each button is in the pressed state or in the non-pressed state at a predetermined regular timing. That is, the CPU 101 detects whether each of the buttons 301A to 304A, 301B to 304B is in the pressed state or in the non-pressed state. Then, the CPU 101 relatively increases the volume of sounds to be output by the sound output unit far from the button in the pressed state. That is, the CPU 101 sets the volume of sounds to be output by the far sound output unit among the first, second, third, and fourth sound output units relatively larger than the volume of sounds to be output by the other sound output units.

The CPU 101 may set the volume of sounds to be output by the first, second, third, and fourth sound output units in such a manner that the farther from the button in the pressed state the sound output unit is, the larger the volume of sounds to be output therefrom.

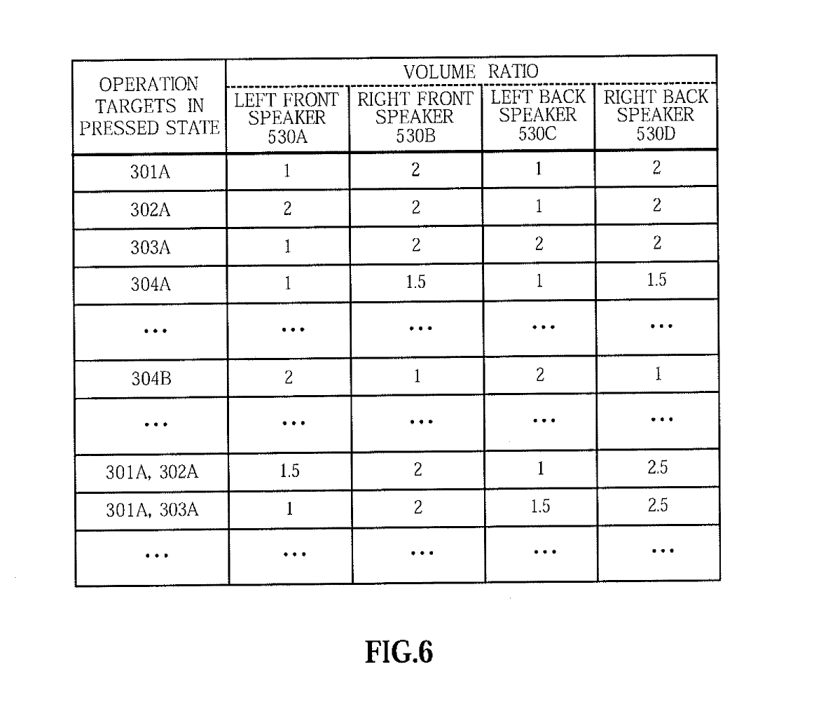

FIG. 6 is a diagram showing an example of the structure of information which defines the volume ratio of sounds to be output from the speakers 530A to 530D. This information is prestored in the DVD-ROM, the external memory 106 or the like.

Typically, the creator of sound data predicts the position of the player when each operation target is pressed. Here, there may be a plurality of operation targets to be pressed. The sound data creator has previously acquired the volume ratio which provides the best volume balance in the predicted position. Then, information which defines the previously acquired volume is stored in the DVD-ROM or the like.

Alternatively, the player may previously acquire the volume ratio which provides the best volume balance in the position of the player in which each operation target is pressed. Then, information which defines the previously acquired volume ratio may be stored in the external memory 106.

The CPU 101 first reads the volume ratio corresponding to an operation target in the pressed state or the combination of operation targets in the pressed state from the DVD-ROM or the like. Next, the CPU 101 sets the volumes of sounds to be output from the speakers 530A to 530D.

For example, when only the button 301A is in the pressed state, the CPU 101 sets the ratio of the volumes of sounds to be output by the first sound output unit, the second sound output unit, the third sound output unit, and the fourth sound output unit as “1:2:1:2.” It is presumed at this time that the player is standing close to the left rear facing the display surface 320 of the monitor 310. Therefore, the CPU 101 sets the volume of a speaker far from the left rear position relatively larger. Therefore, when the position of the player is shifted from the center, the player becomes easy to hear sounds to be heard from the decided direction.

The CPU 101 may relatively increase the volume of sounds to be output by a sound output unit near a button in the pressed state. That is, the CPU 101 may set the volume of sounds to be output from the near sound output unit in the first, second, third, and fourth sound output units relatively larger than the volumes of sounds to be output by the other sound output units.

The information which defines the volume ratio of sound shown in FIG. 6 is just one example, and the volume ratio may be changed arbitrarily. The quantity and positions of speakers whose volumes are to be changed may also be changed freely.

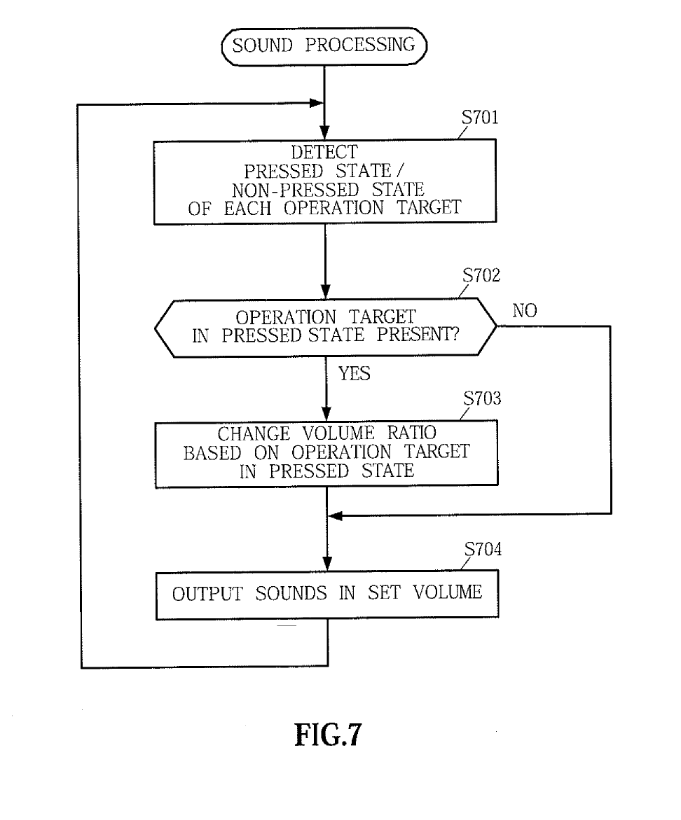

Next, the sound processing which is carried out by the above-described individual units will be explained using the flowchart of FIG. 7. It is assumed here that the controllers 105A and 105B, the monitor 310, and the speakers 530A to 530F are arranged shown in FIG. 5. According to the embodiment, the sound processing device 200 changes the volumes of the speakers 530A to 530D among the speakers 530A to 530F.

First, the CPU 101 detects the pressed states/non-pressed states of the individual operation targets (buttons 301A to 304A and buttons 301B to 304B) (step S701).

The CPU 101 determines whether there is an operation target in the pressed state (step S702).

When the CPU 101 has determined that there is no operation target in the pressed state (step S702; NO), the CPU 101 proceeds to a process of step S704.

When the CPU 101 has determined that there is an operation target in the pressed state (step S702; YES), the CPU 101 changes the volume ratio based on the operation target in the pressed state or the combination of operation targets in the pressed state (step S703).

For example, the CPU 101 acquires a volume ratio corresponding to the operation target in the pressed state or the combination of the operation targets in the pressed state based on the information defining the volume ratio of sounds as exemplified in FIG. 6. The CPU 101 sets the volume of the speakers 530A to 530D so as to provide the acquired volume ratio.

The CPU 101 controls the sound processing unit 109 to output sounds in the volume set up in step S703, or in the default volume (step S704).

The CPU 101 repeats the processes of steps S701 to S704 until reproduction of sound data reaches the end of a musical piece, for example.

According to this embodiment, the sound processing device 200 can output sounds which are easy for the player to hear, regardless of where on the controller 105 the player is positioned. For example, when the player is standing close to a corner of the controller 105, the distances between the player and the individual speakers are not uniform. Even in such a situation, however, sounds are output in the volume balance which makes it easy for the player to hear the sounds.

In the arrangement as shown in FIG. 5, the reference position 350 is located at a place held between the controllers 105A and 105B. During a game, usually, a player does not stand on a place where neither of the controllers 105A and 105B exists. It is therefore considered that the player hardly hears sounds in the best volume balance unless the volume ratio is not changed. However, according to the embodiment, the volume ratio changes according to the motion of the player, so that the player can hear sounds in good volume balance.

### Second Embodiment

Next, another embodiment of the invention will be described. In this embodiment, a game in virtual space is realized by the sound processing device 200, and the volume of sounds to be output from each speaker is changed even in a case where no operation targets are in the pressed states. A detailed description will be given below.

According to this embodiment, it is assumed that the controllers 105A and 105B, the monitor 310, and the speakers 530A to 530F are arranged as shown in FIG. 5.

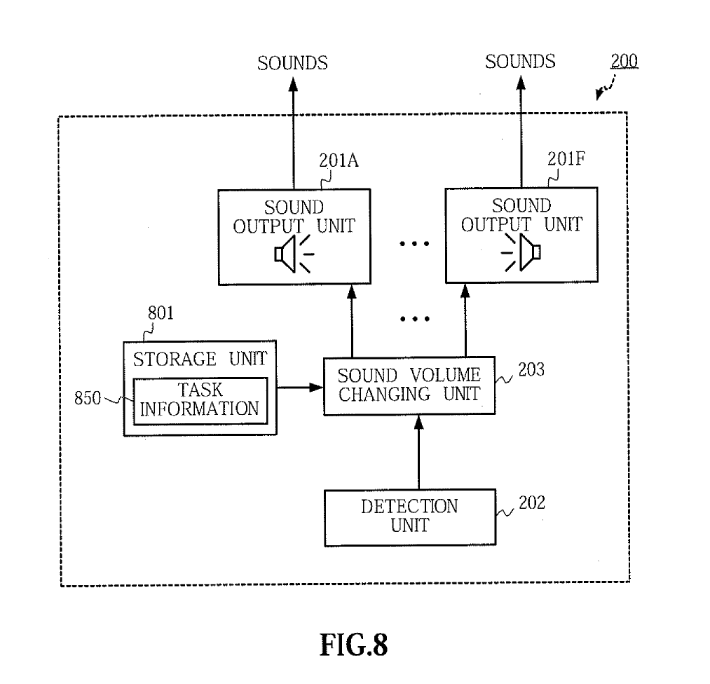

FIG. 8 is a diagram showing the functional configuration of the sound processing device 200 according to the embodiment. The sound processing device 200 further includes a storage unit 801.

The sound processing device 200 includes sound output units 201A to 201F respectively corresponding to the speakers 530A to 530F.

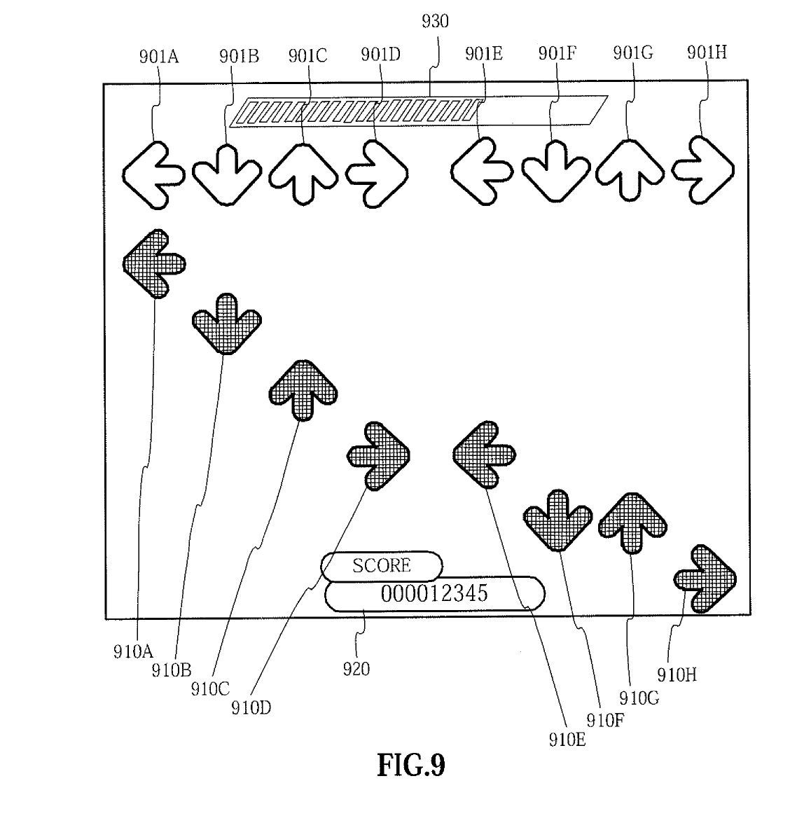

FIG. 9 is an example of the structure of the screen of the game which is played by the sound processing device 200.

First, the outline of the game which is played by the sound processing device 200 according to this embodiment performs will be described.

Static marks 901 (eight marks 901A, 901B, 901C, 901D, 901E, 901F, 901G, and 901H in the diagram), step-position indicating marks 910 (eight marks 910A, 910B, 910C, 910D, 910E, 910F, 910G, and 910H in the diagram), a score 920, a gauge 930, other background images, etc. are displayed on the screen of the game. The static marks 901 are drawn in predetermined fixed positions in the screen. The drawing positions of the step-position indicating marks 910 move with the elapse of time. The score 920 represents the total score the player got in the game. The gauge 930 shows the degree of upsurge of the game.

In the game, music is played with the sound processing device 200. The player can dance to music played by pressing buttons according to instruction marks called “foot notes”. For example, one player can play a dance game using two controllers 105A and 105B.

The step-position indicating marks 910 are displayed in scroll according to the music played. One of Up, Down, Right and Left arrows corresponding to the buttons 301A to 304A, 301B to 304B is drawn on the step-position indicating mark 910.

The static marks 901A to 901H respectively indicate timings at which the player should press the buttons 301A to 304A, 301B to 304B. The image of one of Up, Down, Right and Left arrows is drawn on the static mark 901.

The step-position indicating mark 910 moves toward the position in which the static mark 901 is drawn according to the music playback speed. When the step-position indicating mark 910 has moved to the same position as the static mark 901, the player presses one of the buttons 301A to 304A, 301B to 304B. That is, the player presses one of the buttons 301A to 304A, 301B to 304B corresponding to the directions of the arrows drawn on the static marks 901H to 901H. Then, a predetermined score is added to the score 920 of the player, or the value which is indicated by the gauge 930 will increase.

If a button associated with a task time determined beforehand is pressed by the player, the CPU 101 evaluates that the game result is excellent. In this case, the CPU 101 increases the value indicated by the gauge 930, or the value indicated by the score 920. The closer to the previously determined task time the button-pressed time is, the more excellent the evaluation of the CPU 101 on the game performance becomes.

For example, when a step-position indicating mark 910 has moved to the position in which it overlies one of the static marks 901, the player presses the button corresponding to the arrow indicated by the moved step-position indicating mark 910 (one of the buttons 301A to 304A, 301B to 304B) on one foot (or both feet). Then, the player can make exemplary dance steps that match the music played.

Next, the functional configuration of the sound processing device 200 will be described. A description of the same configuration as that of the foregoing embodiment is omitted.

The storage unit 801 stores task information 850. The CPU 101 reads the task information 850 from the DVD-ROM, and stores it in the RAM 103 temporarily. The CPU 101 and the RAM 103 collaborate to function as the storage unit 801.

The task information 850 is specifically information which associates an operation target to be pressed by the player among a plurality of operation targets (buttons), with the timing.

One set of the combination of operation targets and timings is called “game task.” The task information 850 includes at least one game task.

One game task is expressed like [Equation 1].

P(i)=(T(i), B(x)) [Equation 1]

However, it is assumed that there are N game tasks (N being one or more integers) in the game according to the embodiment. P(i) represents an i-th game task (i being an integer equal to or larger than 1 and equal to or less than N) from the top. T(i) represents a task time corresponding to the game task P(i). B(x) represents the content of the task.

One of a value B(LA) which shows the button 301A, a value B(DA) which shows the button 302A, a value B(UA) which shows the button 303A, a value B(RA) which shows the button 304A, a value B(LB) which shows the button 301B, a value B(DB) which shows the button 302B, a value B(UB) which shows the button 303B, and a value B(RB) which shows the button 304B is specified in the task content B(x).

For example, a certain game task is expressed like [Equation 2].

P(i)=(T(i), B(LA)) [Equation 2]

At this time, the i-th game task P(i) is “pressing the button 301A of the controller 105A at the task time T(i).” The player should just step on the button 301A on a foot when the time in the game comes to T(i).

It is also possible to associate a plurality of task contents with one task time. For example, when two task contents B(LA) and B(UA) are associated with the task time T(i), the game task is expressed like [Equation 4].

P(i)=(T(i), B(LA), B(UA)) [Equation 4]

Alternatively, it may be expressed as two different game tasks as shown in [Equation 5] and [Equation 6].

P(i)=(T(i), B(LA)) [Equation 5]

P(i+1)=(T(i), B(UA)) [Equation 6]

The i-th game task P(i) which is expressed by [Equation 4] or the combination of [Equation 5] and [Equation 6] is “pressing the button 301A of the controller 105A, and pressing the button 303A of the controller 105A at the task time T(i).” If the player steps on the button 301A on one foot and steps on the button 303A on the other foot when the time in the game comes to T(i), it means that the i-th game task P(i) is achieved.

While depression is detected by the detection unit 202, as described above, the sound volume changing unit 203 changes the volume ratio of sounds to be output from each of a plurality of sound output units 201A-201F. That is, the sound volume changing unit 203 changes the volume ratio based on the operation target whose depression has been detected among a plurality of operation targets.

While depression is not detected by the detection unit 202, the sound volume changing unit 203 changes the volume ratio at the timing indicated by the task information 850 based on the operation target to be pressed. It is to be noted that the task information 850 is stored in the storage unit 801.

Suppose that, for example, the game task P(i) is expressed with [Equation 2]. In this case, when the time in the game becomes T(i), the CPU 101 changes the volume ratio of sounds to be output from the speakers 530A to 530D. At this time, the CPU 101 changes the volume ratio based on the operation target to be pressed, namely the button 301A.

Specifically, the CPU 101 acquires the volume ratio “1:2:1:2” corresponding to the button 301A to be pressed referring to the information which defines the volume ratio shown in FIG. 6. Then, the CPU 101 sets the volumes of sounds to be output from the speakers 530A to 530D according to the acquired volume ratio, and outputs the sounds.

In other words, even when none of the buttons 301A to 304A, 301B to 304B are pressed by the player at the time T(i) in the game, sounds are output in the volume balance which makes it easy to hear the sounds in the position where the player should be present.

When the player has attempted to press the button 301A but has missed it at the time T(i) in the game, depression is not detected. However, it is presumed that the position of the player is near the button 301A. Accordingly, the CPU 101 controls the volume so that the volume balance makes it easier for the player to hear near the position where, it is presumed, the player is very likely to be present.

When another button (one of the buttons 302A-304A, 301B to 304B) other than button 301A to be pressed is pressed at the time T(i) in the game, the CPU 101 may change the volume ratio based on the button 301A to be pressed. The CPU 101 may change the volume ratio based on the actually pressed button.

If the volume ratio is changed based on the button 301A to be pressed, for example, the volume balance provides the most easily hearable condition when the game task is achieved. The player can predict the his/her own performance (whether or not the game task has been achieved) by determining whether the volume balance becomes easy to hear. The player need not check his/her own performance on the screen.

If the volume ratio is to be changed based on the actually pressed button, for example, the volume balance provides the most easily hearable condition when the button is pressed. This makes it easier to hear sounds regardless of which button the player presses (in which position the player is present).

There may be a plurality of operation targets to be pressed. When the game task P(i) is expressed by [Equation 4] or [Equation 5] and [Equation 6], for example, the CPU 101 changes the volume ratio at the time T(i) in the game based on the operation target to be pressed. That is, the CPU 101 acquires a volume ratio corresponding to the buttons 301A, 303A, and outputs sounds from the speakers 530A to 530D according to the acquired volume ratio.

Specifically, the CPU 101 acquires the volume ratio “1:2:1.5:2.5” corresponding to the buttons 301A, 303A to be pressed by referring to the information which defines the volume ratio shown in FIG. 6. Then, the CPU 101 sets the volumes of sounds to be output from the speakers 530A to 530D according to the acquired volume ratio, and outputs the sounds.

In addition, the volume ratio may be changed based on the combination of a plurality of buttons which have been pressed actually. When the buttons 301A, 302A are pressed, for example, the CPU 101 acquires the corresponding volume ratio “1.5:2:1:2.5”. Next, the CPU 101 sets the volumes of sounds to be output from the speakers 530A to 530D according to the acquired volume ratio, and outputs the sounds.

When the volume ratio changes according to the combination of a plurality of buttons to be pressed, the player can grasp a proper position at a predetermined timing. When the volume ratio changes based on the actually pressed buttons, the player becomes easier to hear sounds.

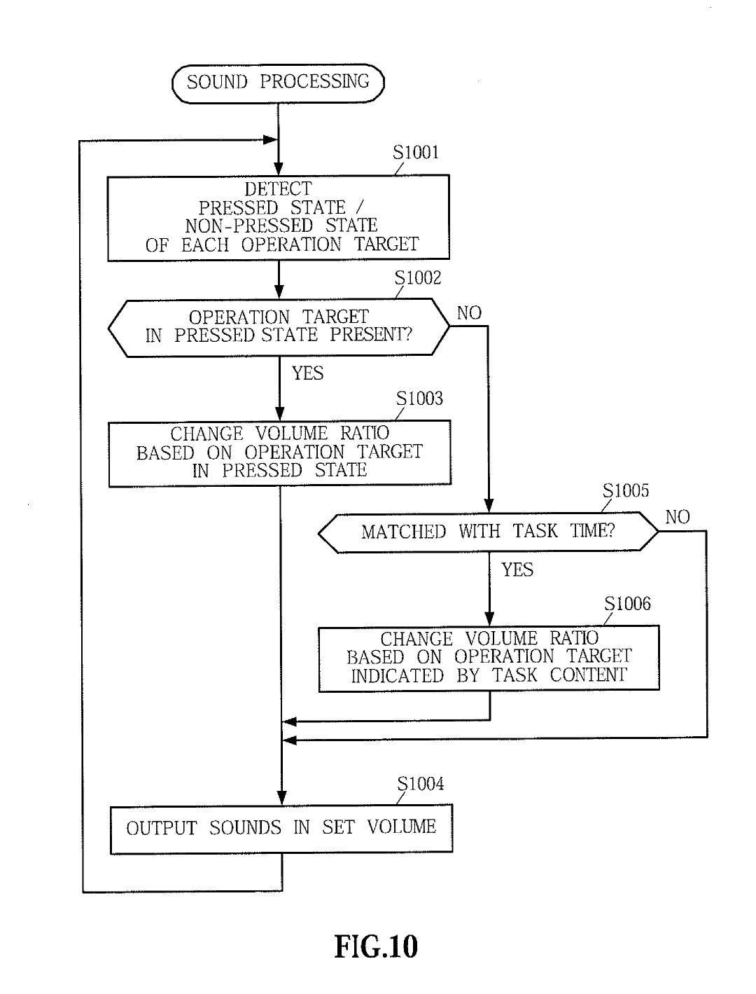

Next, the sound processing of the embodiment will be described using the flowchart of FIG. 10.

First, the CPU 101 detects the pressed state/non-pressed state of each of the operation targets (buttons 301A to 304A and buttons 301B to 304B) (step S1001).

The CPU 101 determines whether there is an operation target in the pressed state (step S1002).

When it is determined that there is an operation target in the pressed state (step S1002; YES), the CPU 101 changes the volume ratio based on the operation target in the pressed state (step S1003).

For example, the CPU 101 acquires the volume ratio corresponding to the operation target in the pressed state (or the combination of a plurality of operation targets, if present, in the pressed state) based on the information which defines the volume ratio of sounds as exemplified in FIG. 6. The CPU 101 sets the volumes of the speakers 530A to 530D to provide the acquired volume ratio.

The CPU 101 controls the sound processing unit 109 to output sounds in the volume set in step S1003 (step S1004).

When having determined that there is no operation target in the pressed state (step S1002; NO), the CPU 101 determines whether the current time in the game matches with the task time which is specified by any one of game tasks included in the task information 850 (step S1005).

When having determined that there is a matched task time (step S1005; YES), the CPU 101 changes the volume ratio based on the operation target (button) which is indicated by the task content associated with the matched task time (step S1006), and outputs sounds in the volume set in step S1006 (step S1004).

When the current time in the game is within a predetermined period around the task time, the CPU 101 determines that the time in the game matches with the task time. For example, when the task time is “the fourth meter in the first bar of a musical piece”, the time in the game is the period that is determined as being matched with the period of “one meter around the fourth meter in the first bar of a musical piece”.

However, this predetermined period can be defined arbitrarily. The predetermined period may be defined in seconds. The predetermined period may be expressed only by the period after the task time or only the period before the task time, not around the task time.

When the CPU 101 determines that there is not a matched task time (step S1005; NO), on the other hand, the CPU 101 outputs sounds with the volume set to the default value (step S1004).

The CPU 101 repeats the processes of steps S1001 to S1006 until reproduction of sound data reaches the end of a musical piece, for example.

According to this embodiment, the sound processing device 200 can output sounds which are easy for the player to hear, regardless of where the player is positioned. Even when the player is standing close a corner of the controller 105, and the distances between the player and the individual speakers are not uniform, the sound processing device 200 can output sounds in the volume balance which makes it easy for the player to hear the sounds. At that time, there may be a case where the operation target is not in the pressed state. That is, there may be a case where the player is not pressing a button. Even in such a case, however, the sound processing device 200 can reproduce sounds in the volume balance which facilitates hearing the sounds in the position where the player is presumed to be present, or the position where the player should be present.

### Third Embodiment

Next, another embodiment of the invention will be described. According to this embodiment, a change in volume balance can also be a hint for a player to clear a game executed by the sound processing device 200. A description will be given on the assumption that the controller 105, the monitor 310, and the speakers 330A and 330B are arranged as shown in FIG. 3.

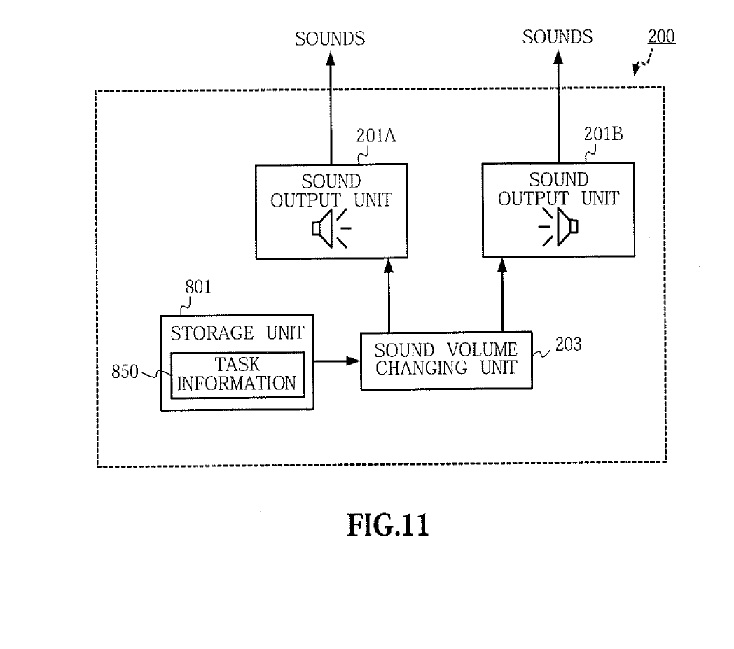

FIG. 11 is a diagram showing the functional configuration of the sound processing device 200 according to this embodiment. The sound processing device 200 includes a storage unit 801, a plurality of sound output units 201 (two units 201A and 201B in FIG. 11), and a sound volume changing unit 203.

Since the configurations of the storage unit 801 and the sound output units 201A, 201B are the same as those of the foregoing embodiment, their detailed descriptions are omitted.

The sound volume changing unit 203 according to the embodiment changes the volume ratio of sounds to be output from each of the sound output units 201A and 201B based on the operation target that is associated with the timing which is determined by using the task time stored in the storage unit 801 and the current time in the game.

In more details, the sound volume changing unit 203 acquires a task time later than the current time in the game but closest to the current time. Next, the sound volume changing unit 203 changes the volume ratio of sounds to be output from each of the sound output units 201A and 201B based on the button which is indicated by the task content stored in association with the acquired task time.

In other words, the volume ratio of sounds changes based on the button that is indicated by a next game task which the player should achieve.

For example, an i-th game task P(i) is expressed by [Equation 7], and an (i+1)th game task P(i+1) is expressed by [Equation 8].

P(i)=(T(i), B(L)) [Equation 7]

P(i+1)=(T(i+1), B(R)) [Equation 8]

The game task P(i) is “pressing the button 301 at a time T(i) in the game.” The game task P(i+1) is “pressing the button 304 at the time T(i+1) in the game.”

The CPU 101 acquires a volume ratio associated with the button 304 which is indicated by the game task P(i+1) which the player should achieve next. Then, while the time in the game lies between T(i) and T(i+1), the CPU 101 sets the volume according to the acquired volume ratio, and outputs sounds.

The CPU 101 sets the volume of sounds to be output by that one of the sound output units 201A and 201B which is far from the button indicated by the game task to be achieved next relatively larger than the volume of sounds to be output by the other sound output unit.

For example, the CPU 101 refers to the information which defines the volume ratio of sounds to be output from the speaker 330A and 330B. Next, the CPU 101 acquires the volume ratio corresponding to the button 304 to be pressed (for example, “volume of the speaker 330A:volume of the speaker 330B=2:1”). Then, the CPU 101 sets the volumes of sounds to be output from the speakers 330A, 330B according to the acquired volume ratio, and outputs the sounds.

At this time, the volume of sounds to be output from the speaker 330B does not change after the game task P(i). On the other hand, the volume of sounds to be output from the speaker 330A becomes relatively larger than the volume of the sounds to be output from the speaker 330B after the game task P(i) until the game task P(i+1).

Since the volume from the left becomes larger, the player can presume that the content of the next game task P(i+1) is movement in the direction of making the sound balance becomes better. That is, the player can presume that he/her should move rightward toward the monitor 310.

Alternatively, the CPU 101 may set the volume of sounds to be output by that one of the sound output units 201A and 201B which is near the button indicated by the game task to be achieved next relatively larger than the volume of sounds to be output by the other sound output unit. In this case, the player can presume that the content of the next game task P(i+1) is movement in the direction of making the volume relatively larger.

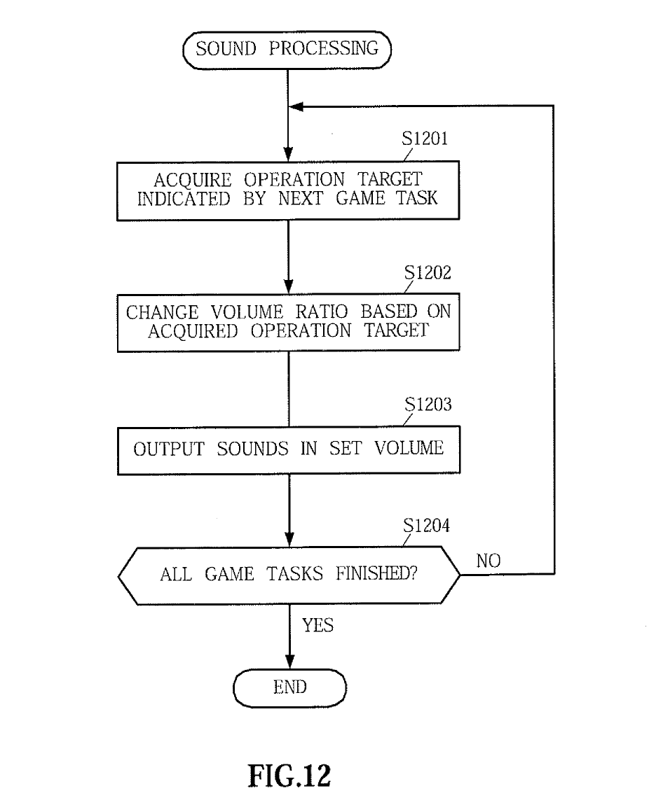

Next, the sound processing that is executed by the sound processing device 200 according to the embodiment will be described using the flowchart of FIG. 12.

First, the CPU 101 acquires an operation target which is indicated by a next game task (step S1201). The next game task is a game task which has not reached its task time yet, and whose task time is closest to the current time in the game.

The CPU 101 changes the volume ratio based on the operation target acquired in step S1201 (step S1202), and sets the volumes of the speakers 530A to 530D.

For example, the CPU 101 sets the volume of sounds to be output by the sound output unit which is far from the button indicated by the next game task relatively larger than the volume of sounds to be output by the other sound output unit until the time in the game reaches the task time indicated by the next game task.

The CPU 101 outputs sounds in the set volume (step S1203).

When not all the game tasks are completed (step S1204; NO), the CPU 101 repeats the processes of the steps S1201 to S1203.

When all the game tasks are completed (step S1204; YES), the CPU 101 terminates the sound processing.

According to the embodiment, the sound processing device 200 can output sounds which are easy to hear in a proper position for the player to achieve the game task. The player should move near the position where the volume balance is good. According to the embodiment, therefore, the player can obtain a hint for capturing the game from the volume balance.

In step S1202, the CPU 101 may set the volume of sounds to be output by the sound output unit which is near from the button indicated by the next game task relatively larger than the volume of sounds to be output by the other sound output unit until the time in the game reaches the task time indicated by the next game task. In this case, changing the volume balance, the sound processing device 200 can provide the player with an indication of the proper position of the player to achieve the next game task. The player can obtain a hint for capturing the game such that he/she should be positioned near the position where sounds are heard loud in order to achieve the next game task.

### Fourth Embodiment

Next, another embodiment of the invention will be described. According to this embodiment, the volume balance changes according to the game performance of a player. Here, a description will be given on the premise that the controllers 105A and 105B, the monitor 310, and the speakers 530A to 530F are arranged as shown in FIG. 5.

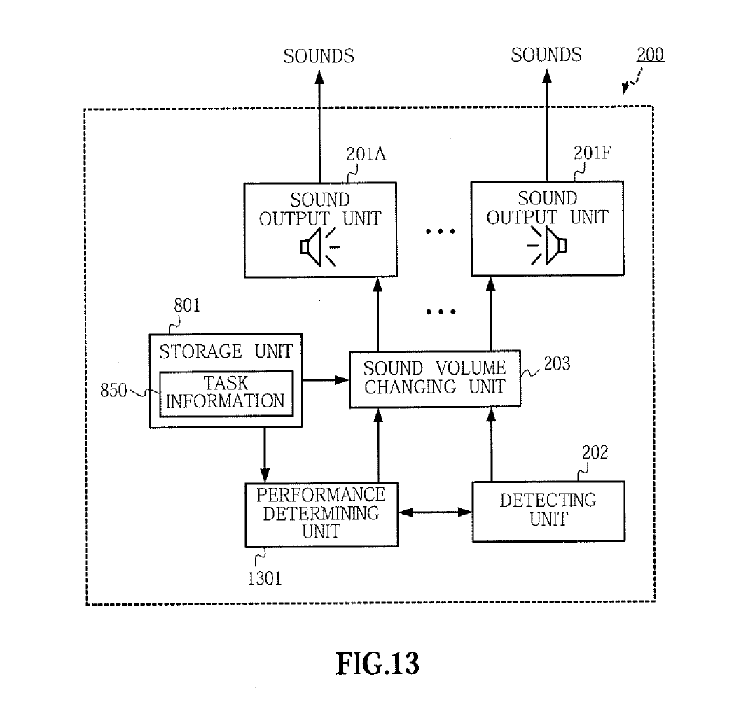

FIG. 13 is a diagram showing the functional configuration of the sound processing device 200 according to this embodiment. The sound processing device 200 further includes a performance determining unit 1301.

The performance determining unit 1301 determines the performance of a player on a game task included in task information 850. The performance determining unit 1301 determines the performance based on existence/absence of depression detected by the detection unit 202, and the task information 850 stored in the storage unit 801. When there are a plurality of game tasks, the performance determining unit 1301 determines the performance on each game task. The CPU 101 functions as the performance determining unit 1301.

Specifically, when an operation target corresponding to a task content B(x) indicated by a game task P(i) is in the pressed state at a time T(i) in the game which is indicated by an i-th game task P(i), the CPU 101 determines that the game task P(i) has archived by the player.

When the operation target corresponding to the task content B(x) indicated by the game task P(i) is in the non-pressed state at the time T(i) in the game indicated by the i-th game task P(i), on the other hand, the CPU 101 determines that the game task P(i) has not archived by the player.

Achievement of the game task P(i) by the player is also expressed herein as the performance of the player on the game task P(i) being excellent. Further, non-achievement of the game task P(i) by the player is also expressed as the performance of the player on the game task P(i) being not excellent (or being poor).

Alternatively, when the operation target corresponding to the task content B(x) which is indicated by the game task P(i) is in the pressed state within a predetermined period around the time T(i) in the game which is indicated by the game task P(i), the CPU 101 determines that the game task P(i) has archived by the player. That is, a tolerance range where the performance of a player is determined as being excellent may be provided in a period around the task time T(i). Even when the player sets the operation target corresponding to the task content B(x) in the pressed state but the pressing timing does not completely match with the task time T(i), the player is regarded as having achieved the game task P(i).

In case of providing the tolerance range, the CPU 101 may determine an achievement ratio (degree of achievement) which shows with what accuracy the achievement was made, rather than merely determines whether the game task P(i) has been achieve.

For example, when the operation target which is indicated by the game task P(i) is pressed within a first tolerance range provided in a period around the task time T(i), the CPU 101 adds a first score to a score 920. When the operation target which is indicated by the game task P(i) is pressed within a second tolerance range provided in a period around the task time T(i), the CPU 101 adds a second score to the score 920. The second tolerance range is a period longer than the first tolerance range, and it is desirable that the second score be less than the first score.

As described above, the sound volume changing unit 203 changes the volume ratio of sounds to be output from the sound output units 201A to 201F. When the performance determining unit 1301 has determined that the performance is excellent, the sound volume changing unit 203 changes the volume ratio based on the operation target which is indicated by a next game task the player will challenge. That is, the sound volume changing unit 203 changes the volume ratio based on that of a plurality of operation targets (buttons 301A to 304A and buttons 301B to 304B) which is stored in the storage unit 801 in association with the timing which is later than the current time but closest thereto.

When the performance determining unit 1301 has determined that the performance is not excellent, the sound volume changing unit 203 changes the volume ratio of sounds to be output from the sound output units 201A to 201F based on the operation target whose depression is detected among a plurality of operation targets.

Suppose that, for example, four consecutive game tasks are expressed like [Equation 9] to [Equation 12].

P(i)=(T(i), B(LA)) [Equation 9]

P(i+1)=(T(i+1), B(RA)) [Equation 10]

P(i+2)=(T(i+2), B(LB)) [Equation 11]

P(i+3)=(T(i+3), B(RB)) [Equation 12]

The game tasks indicated by [Equation 9] to [ Equation 12] are “pressing the buttons in order of button 301A→button 304A→button 301B→button 304B.” When those game tasks are achieved, the player will have moved toward the monitor 310 from the left end to the right end.

When the CPU 101 determines that the i-th game task P(i) has been achieved, the CPU 101 changes the volume ratio of sounds to be output from the speakers 530A to 530D to the volume ratio associated with the operation target which is indicated by the next game task P(i+1) during a period from the point of time of the decision that the game task P(i) has been achieved until the time when the time in the game reaches the task time T(i+1) of the next game task P(i+1).

Alternatively, when the CPU 101 determines that the i-th game task P(i) has been achieved, the CPU 101 may change the volume ratio of sounds to be output from the speakers 530A to 530D to the volume ratio associated with the operation target which is indicated by the next game task P(i+1) during a period from the point of time of the decision that the game task P(i) has been achieved until the time when an achievement relating to the next game task P(i+1) is decided.

When game tasks are achieved in succession by a predetermined number of times (in so-called “combo”), the CPU 101 may determine that the performance is excellent. In this case, when game tasks are achieved in succession by a predetermined number of times, the CPU 101 changes the volume ratio to the one associated with the next game task. Namely, when the CPU 101 determines that the i-th game task P(i) and (i+1)th game task P(i+1) have been achieved in succession, the CPU 101 may change the volume ratio associated with the operation target indicated by a next game task P(i+2). The CPU 101 may change the volume ratio of sounds to be output from the speakers 530A to 530D until the time in the game reaches a task time T(i+2) of the next game task P(i+2) since the time of decision that the game task P(i+1) has been achieved.

That is, when the player achieves game tasks in succession, the CPU 101 changes the volume ratio so as to match the motion of the positions of the player. When the player achieves game tasks in succession, the player can hear sounds in the easy-to-hear volume balance that matches the motion of the player.

The predetermined number of times (the number of combos) is arbitrary. When the predetermined number of times is set to 3, for example, the CPU 101 determines that the i-th game task P(i), the (i+1)th game task P(i+1), and the (i+2)th game task P(i+2) have been achieved in succession, the CPU 101 changes the volume ratio to the one associated with the operation target indicated by a next game task P(i+3). Specifically, the CPU 101 changes the volume ratio of sounds to be output from the speakers 530A to 530D as mentioned above until the time in the game reaches a task time T(i+3) of the next game task P(i+3) since the time of decision that the game task P(i+2) has been achieved.

When one of the operation targets has been pressed, and game tasks have not been achieved by a predetermined number of times in succession, the CPU 101 changes the volume ratio of sounds to be output from the speakers 530A to 530D to the volume ratio associated with another operation target pressed. When it is assumed that although the i-th game task P(i) and (i+1)th game task P(i+1) have been achieved in succession, another operation target other than the one indicated by the task content at a task time T(i+2) indicated by an (i+2)th game task P(i+2), so that the CPU 101 determines that the game task P(i+2) has not been achieved, the CPU 101 changes the volume ratio in the manner mentioned above during a period from the point of time when the CPU 101 has determined that the game task P(i+2) has not been achieved to a point of time when the time in the game reaches a task time T(i+3) of a next game task P(i+3).

When none of the operation targets have been pressed, and game tasks have not been achieved by a predetermined number of times in succession, the CPU 101 changes the volume ratio of sounds to be output from the speakers 530A to 530D to the default volume ratio. The default volume ratio typically permits sounds to be heard in the best volume balance in the reference position 350. Suppose that, for example, although the i-th game task P(i) and (i+1)th game task P(i+1) have been achieved in succession, no operation targets have been pressed at the task time T(i+2) indicated by the (i+2)th game task P(i+2), so that the CPU 101 determines that the game task P(i+2) has not been achieved. In this case, the CPU 101 changes the volume ratio in the manner mentioned above during a period from the point of time when the CPU 101 has determined that the game task P(i+2) has not been achieved to a point of time when the time in the game reaches a task time T(i+3) of the next game task P(i+3).

Since the configurations of the storage unit 801, the sound output units 201A to 201F, and the detection unit 202 are the same as those of the foregoing embodiment, their detailed descriptions are omitted.

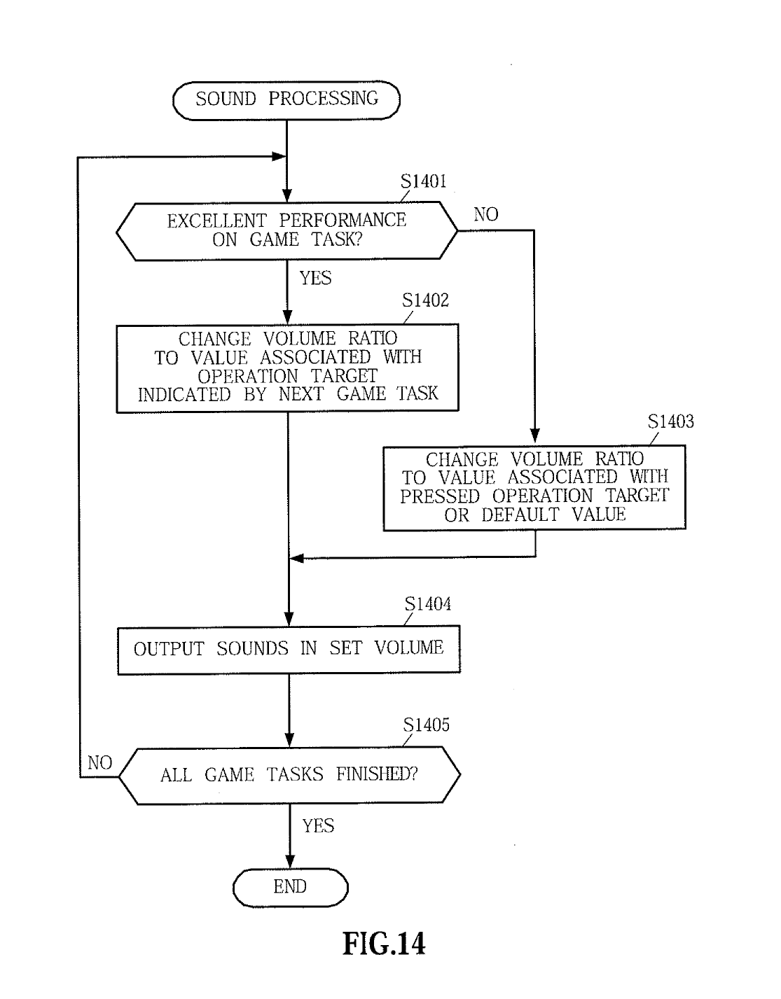

Next, the sound processing that is executed by the sound processing device 200 according to the embodiment will be described using the flowchart of FIG. 14.

First, the CPU 101 shows a game task P(i) to the player, detects the pressed state/non-pressed state of an operation target, and determines whether the performance of the player on the game task P(i) is excellent (step S1401).

For example, when an operation target which is indicated by the task content of the game task P(i) is in the pressed state within the predetermined tolerance range around a task time T(i), the CPU 101 determines that the performance of the player on the game task P(i) is excellent. Otherwise, the CPU 101 determines that the performance of the player on the game task P(i) is not excellent.

When having determined that the performance of the player on the game task P(i) is excellent (step S1401; YES), the CPU 101 changes the volume ratio to a value associated with an operation target which is indicated by a next game task P(i+1) (step S1402).

Suppose that, for example, the game tasks P(i) and P(i+1) are respectively expressed by [Equation 9] and [Equation 10]. When the CPU 101 determines that the performance of the player on the game task P(i) is excellent, the CPU 101 changes the volume ratio to the value associated with the operation target indicated by the game task P(i+1) during a period from the time of having determined the performance on the game task P(i) to the time of determining the performance on the next game task P(i+1).

When having determined that the performance of the player on the game task P(i) is not excellent (step S1401; NO), on the other hand, the CPU 101 changes the volume ratio to the value associated with the pressed operation target, or the default value (step S1403).

When another operation target which is not the operation target indicated by the task content at the task time T(i) indicated by the game task P(i), the CPU 101 determines that the performance on the game task P(i) is not excellent. Then, the CPU 101 changes the volume ratio to a value associated with the another operation target pressed.

Even when no operation targets have been pressed at the task time T(i) indicated by the game task P(i), the CPU 101 determines that the performance of the player on the game task P(i) is not excellent. Then, the CPU 101 changes the volume ratio to the default value.

Then, the CPU 101 outputs sounds in the volume set in step S1402 or S1403 (step S1404).

The CPU 101 determines whether all the game tasks have been finished (step S1405).

When not all the game tasks have not been finished (step S1405; NO), the CPU 101 returns to the process of step S1401. Then, the CPU 101 determines whether the performance on the next game task P(i+1) is excellent. When all the game tasks have been finished (step S1405; YES), on the other hand, the CPU 101 terminates the sound processing.

According to the embodiment, when the player has achieved a game task, the sound processing device 200 outputs sounds which are easy to hear in a proper position to achieve a next game task. To achieve the next game task, the player should move near a position where the volume balance is good. Therefore, the player can obtain a hint for capturing the game from the volume balance. When the player cannot achieve the game task, the sound processing device 200 outputs sounds which are easy to hear in the position of failure. Therefore, the player can hear sounds in the volume balance which makes it easy to hear the sounds in the position where the player is currently present.

The invention is not limited to the above-described embodiments, and may be modified and applied in various forms. It is also possible to freely combine the individual components of the foregoing embodiments.

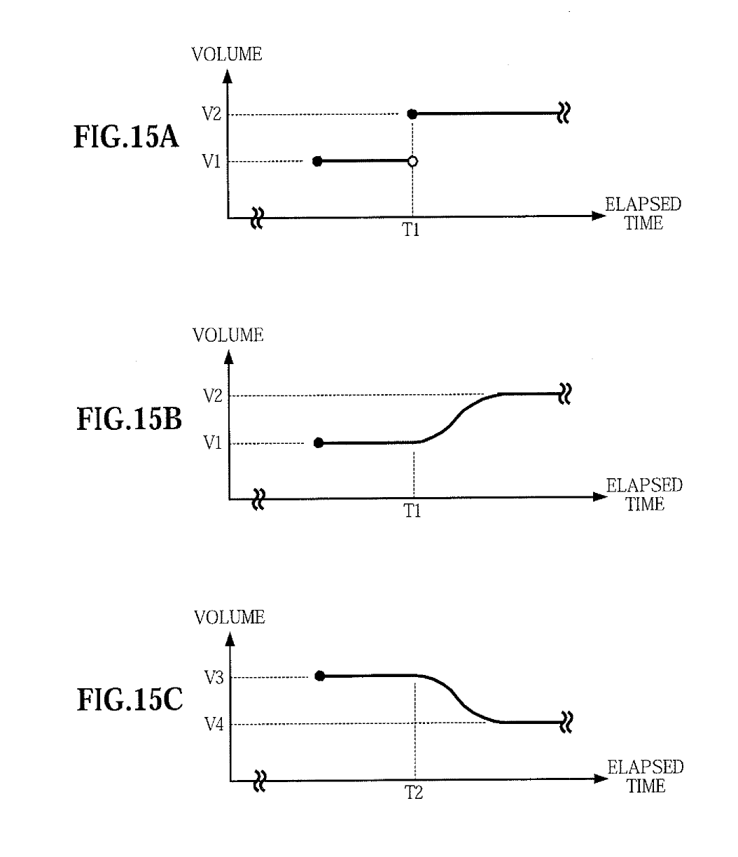

FIGS. 15A to 15C are diagrams which show, in graph, the relationship between the elapsing time and the volume of sounds to be output from a certain speaker. In changing the volume of a certain speaker, the CPU 101 may change the volume discontinuously as shown in FIG. 15A. Alternatively, the CPU 101 may change the volume continuously (smoothly) as shown in FIG. 15B or FIG. 15C.

When it is determined that there is an operation target in the pressed state at the time T1 (step S702; YES), for example, the CPU 101 may instantaneously increase the volume of the speaker located farthest from the pressed operation target from V1 to V2 in step S703, as shown in FIG. 15A.

Alternatively, the CPU 101 may gradually increase the volume of the speaker located farthest from the pressed operation target so as to converge from V1 to V2, as shown in FIG. 15B.

The same is true of the case of reducing the volume. That is, the CPU 101 may gradually reduce the volume of the speaker located closest to the pressed operation target so as to converge from V3 to V4, as shown in FIG. 15C.

The contents of the game played by the sound processing device 200 are not limited to a music game mentioned above. The invention can be adapted to arbitrary games which use the controller 105 having a plurality of operation targets. Further, the invention can be used as a scheme of adjusting the volume balance to the suitable one according to the position of a user in various devices which provide users with video images accompanied with generated sounds, such as film showing, as well as games.

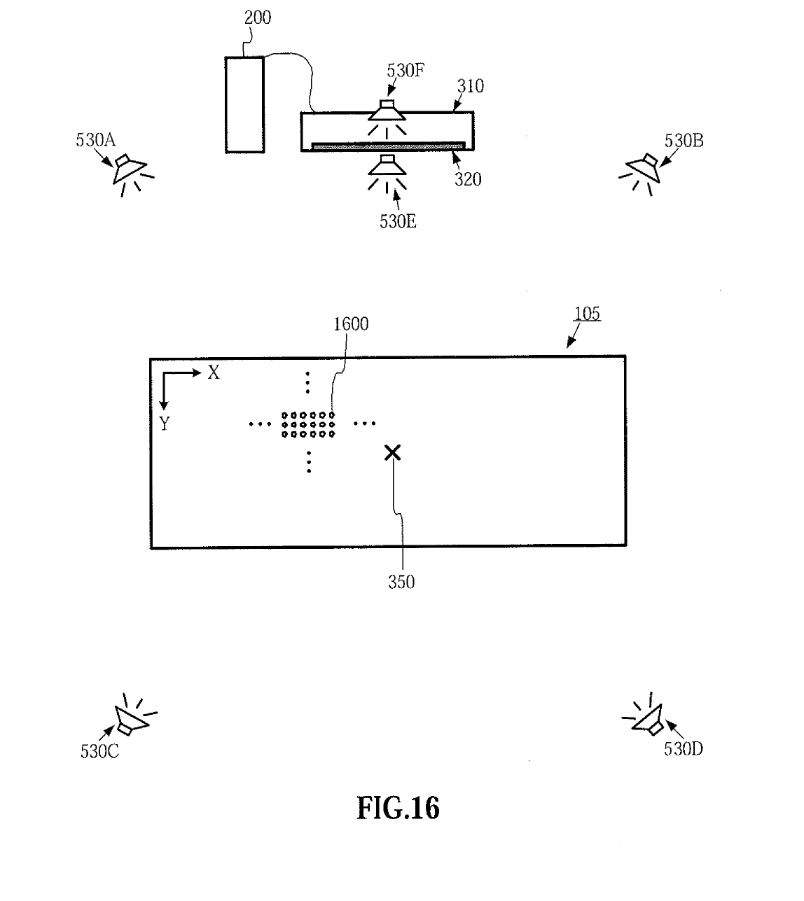

The form of the controller 105 and the arrangement of operation targets (buttons) are not limited to those mentioned above. For example, as shown in FIG. 16, the controller 105 may have a form like a carpet so that an arbitrary pressing position (contact position) on the surface can be detected. A predetermined coordinate system (typically X-Y coordinate system) is defined on the surface of the controller 105. The CPU 101 acquires the coordinates values of a pressing position, and changes the volume of sounds to provide a volume ratio associated with the acquired coordinate values. This is substantially equivalent to the controller 105 having countless logical operation targets 1600 which are recognizable by the CPU 101.

A program for allowing a computer to operate as the entire sound processing device 200 or a part thereof may be stored in a computer-readable recording medium, such as a memory card, CD-ROM, DVD or MO (Magneto Optical disk), for distribution, and may be installed on another computer to permit this computer to operate as the above-described means, or execute above-described steps.

Further, the program may be stored on a disk unit or the like provided in a server apparatus on the Internet, and may be superimposed on a carrier wave to be downloaded onto a computer, for example.

This application claims the benefit of Japanese Patent Application No. 2009-132875, the entire disclosure of which is incorporated by reference herein.

As described above, the invention can provide a sound processing device, a sound processing method, an information storage medium and a program that can output sounds in a volume balance which makes it easier for players to hear the sounds.

### REFERENCE SIGNS LIST

100 Information processing apparatus
101 CPU
102 ROM
103 RAM
104 Interface
105, 105A, 105B Controller
106 External memory
107 DVD-ROM drive
108 Image processing unit
109 Sound processing unit
110 NIC
200 Sound processing device
201, 201A, 201B Sound output unit
202 Detection unit
203 Sound volume changing unit
301-304, 301A-304A, 301B-304B Operation target (button)
310 Monitor
320 Display surface of the monitor
330A, 330B, 530A-530F Speaker
350 Reference position
801 Storage unit
850 Task information
901 to 908 Static mark
910A-910H Step-position indicating mark
920 Score
930 Gauge
1301 Performance determining unit
1600 Logical operation target

What is claimed is:

1. A sound processing device (200) comprising:
a plurality of sound output units (201) that output sounds;
a detection unit (202) that detects existence/absence of depression performed by a player on each of a plurality of operation targets arranged in predetermined positions; and
a sound volume changing unit (203) that changes a volume ratio of a sound to be output from each of the plurality of sound output units (201) based on an operation target whose depression has been detected among the plurality of operation targets.

2. The sound processing device (200) according to claim 1, further comprising a storage unit (801) that prestores task information (850) which associates an operation target to be subjected to depression by the player among the plurality of operation targets with a timing at which the depression is to be performed,
wherein the sound volume changing unit (203) changes the volume ratio at the timing to be stored based on the operation target whose depression is to be performed while the depression is not detected by the detection unit (202).

3. The sound processing device (200) according to claim 2, further comprising a performance determining unit (1301) that determines a performance of the player about the task information (850) based on existence/absence of depression detected by the detection unit (202), and the task information (850) stored in the storage unit (801),
wherein when the performance determining unit (1301) determines that the performance is excellent, the sound volume changing unit (203) changes the volume ratio of a sound to be output from each of the plurality of sound output units (201) based on an operation target among the plurality of operation targets which is stored in association with a timing later than a current time and closest to the current time, and
otherwise, the sound volume changing unit (203) changes the volume ratio of a sound to be output from each of the plurality of sound output units (201) based on an operation target whose depression has been performed among the plurality of operation targets.

4. The sound processing device (200) according to claim 1, wherein the sound volume changing unit (203) relatively increases a volume of a sound to be output by a sound output unit (201) among the plurality of sound output units (201) which is far from an operation target whose depression has been detected.

5. The sound processing device (200) according to claim 1, wherein the sound volume changing unit (203) relatively increases a volume of a sound to be output by a sound output unit (201) among the plurality of sound output units (201) which is near an operation target whose depression has been detected.

6. A sound processing device (200) comprising:
a storage unit (801) that prestores task information (850) which associates an operation target to be subjected to depression by a player among a plurality of operation targets to be operated arranged in predetermined positions with a timing at which the depression is to be performed;
a plurality of sound output units (201) that output sounds; and
a sound volume changing unit (203) that changes a volume ratio of a sound to be output from each of the plurality of sound output units (201) based on an operation target among the plurality of operation targets which is associated with a timing which is determined by using the timing to be stored and a current time.

7. The sound processing device (200) according to claim 6, wherein the sound volume changing unit (203) changes the volume ratio of a sound to be output from each of the plurality of sound output units (201) based on an operation target among the plurality of operation targets which is stored in the storage unit (801) in association with a timing later than the current time and closest to the current time.

8. The sound processing device (200) according to claim 7, wherein the sound volume changing unit (203) relatively increases a volume of a sound to be output by a sound output unit (201) among the plurality of sound output units (201) which is far from an operation target which is stored in the storage unit (801) in association with a timing later than the current time and closest to the current time.

9. The sound processing device (200) according to claim 7, wherein the sound volume changing unit (203) relatively increases a volume of a sound to be output by a sound output unit (201) among the plurality of sound output units (201) which is near an operation target which is stored in the storage unit (801) in association with a timing later than the current time and closest to the current time.

10. A sound processing method to be executed by a sound processing device having a plurality of sound output units (201), a detection unit (202), and a sound volume changing unit (203), the method comprising:
a sound outputting step of causing each of the plurality of sound output units (201) to output a sound;
a detection step of detecting existence/absence of depression performed by a player on each of a plurality of operation targets arranged in predetermined positions; and
a sound volume changing step of changing a volume ratio of a sound to be output from each of the plurality of sound output units (201) based on an operation target whose depression has been detected among the plurality of operation targets.

11. A sound processing method to be executed by a sound processing device having a storage unit (801) which prestores task information (850) which associates an operation target to be subjected to depression by a player among a plurality of operation targets to be operated arranged in predetermined positions with a timing at which the depression is to be performed, a plurality of sound output units (201), and a sound volume changing unit (203), the method comprising:
a sound outputting step of causing each of a plurality of sound output units (201) to output a sound; and
a sound volume changing step of changing a volume ratio of a sound to be output from each of the plurality of sound output units (201) based on an operation target among the plurality of operation targets which is associated with a timing which is determined by using the timing to be stored and a current time.

12. A computer-readable information storage medium storing a program allowing a computer to function as:
a plurality of sound output units (201) that output sounds;
a detection unit (202) that detects existence/absence of depression performed by a player on each of a plurality of operation targets arranged in predetermined positions; and
a sound volume changing unit (203) that changes a volume ratio of a sound to be output from each of the plurality of sound output units (201) based on an operation target whose depression has been detected among the plurality of operation targets.

13. A computer-readable information storage medium storing a program allowing a computer to function as:
a storage unit (801) that prestores task information (850) which associates an operation target to be subjected to depression by a player among a plurality of operation targets to be operated arranged in predetermined positions with a timing at which the depression is to be performed;
a plurality of sound output units (201) that output sounds; and
a sound volume changing unit (203) that changes a volume ratio of a sound to be output from each of the plurality of sound output units (201) based on an operation target among the plurality of operation targets which is associated with a timing which is determined by using the timing to be stored and a current time.

14. A program allowing a computer to function as:
a plurality of sound output units (201) that output sounds;
a detection unit (202) that detects existence/absence of depression performed by a player on each of a plurality of operation targets arranged in predetermined positions; and
a sound volume changing unit (203) that changes a volume ratio of a sound to be output from each of the plurality of sound output units (201) based on an operation target whose depression has been detected among the plurality of operation targets.

15. A program allowing a computer to function as:
a storage unit (801) that prestores task information (850) which associates an operation target to be subjected to depression by a player among a plurality of operation targets to be operated arranged in predetermined positions with a timing at which the depression is to be performed;
a plurality of sound output units (201) that output sounds; and
a sound volume changing unit (203) that changes a volume ratio of a sound to be output from each of the plurality of sound output units (201) based on an operation target among the plurality of operation targets which is associated with a timing which is determined by using the timing to be stored and a current time.
